(19) United States
(12) Patent Application Publication
(10) Pub. No.: US 2026/0008505 A1
(43) Pub. Date: Jan. 8, 2026

(54) ADJUSTABLE RIDE HEIGHT VEHICLE AERODYNAMIC SYSTEM

(71) Applicants: MULTIMATIC INC, Markham (CA); MULTIMATIC PATENTCO LLC, Novi, MI (US)

(72) Inventor: John Campbell Aird, Thetford (GB)

(21) Appl. No.: 19/117,786

(22) PCT Filed: Jan. 16, 2024
(86) PCT No.: PCT/US2024/011601

§ 371 Date: Apr. 2, 2025

Related U.S. Application Data
(60) Provisional application No. 63/441,504, filed on Jan. 27, 2023.

(51) Int. Cl. B62D 35/00; B62D 37/02

(52) U.S. Cl. CPC B62D 35/005; B62D 35/007; B62D 37/02

(57) ABSTRACT

An adjustable ride height vehicle aerodynamic system comprises an aerodynamic element ride actuator and an aerodynamic element angle actuator connected in series and mounted in a vehicle. An aerodynamic element is adapted to rest in an inactive stowed position and to move from the stowed position to at least one active deployed position at an angle in relation to a vehicle underbody under the control of the aerodynamic element angle actuator to alter vehicle aerodynamic characteristics. The aerodynamic element ride actuator is adapted to extend and retract synchronously with a respective vehicle ride height increase and decrease, and the aerodynamic element angle actuator is adapted to extend and retract respectively to deploy and to stow the aerodynamic element.

### CROSS-REFERENCE TO RELATED APPLICATIONS

This application claims priority to U.S. Provisional Application No. 63/441,504 filed on Jan. 27, 2023, and is incorporated herein by reference.

### BACKGROUND

Automotive vehicles, especially high performance or racing vehicles, have employed aerodynamic elements to affect vehicle aerodynamic characteristics for many years. Often, the aerodynamic elements are fixed in the same position whether the vehicle is in motion or not. Sometimes, on the other hand, such elements are deployed while driving, for example, upon reaching a certain speed. It is frequently advantageous to deploy an aerodynamic element while the vehicle is in motion in order to change the aerodynamic characteristics of the vehicle, depending on driving conditions.

Some vehicles are equipped with an adjustable ride height feature. This may include a higher ride height comfort mode used, for example, on intermittently uneven driving surfaces, typically roads, and a sport mode with a reduced ride height to aid with vehicle dynamics on more even driving surfaces such as racetracks. This is typically achieved through the use of hydraulic actuators or air springs linked to the vehicle suspension system.

It would be advantageous to employ a vehicle aerodynamic system which automatically accommodates a change in ride height by also changing the deployed position of an aerodynamic element, and to do this without affecting the stowed position of the aerodynamic element, thus allowing continuous switching of the aerodynamic element between positions corresponding to vehicle comfort ride height and sport modes. These changes would advantageously be made to the aerodynamic element while the vehicle ride height is altered between a higher comfort ride height of the vehicle and a lower sport ride height of the vehicle. The mechanism would advantageously be applicable to a number of active aerodynamic elements, such as rear wings and spoilers, tire wake deflectors, air dams, underbody devices, etc.

It would also be advantageous for the mechanism not to require reliance on additional sensors or electronic components to control the variation in aerodynamic positions of the aerodynamic element depending on vehicle ride height.

Moreover, it would be an advantage for the mechanism to be able to be used to drive the position of active aerodynamic elements on the underbody of a vehicle or on other locations of a vehicle.

### SUMMARY

An adjustable ride height aerodynamic system has been developed which overcomes these prior art issues. The adjustable ride height aerodynamic system automatically accommodates a change in vehicle ride height by also changing the deployed position of an aerodynamic element, without affecting its stowed position, thus allowing continuous switching of the aerodynamic element between positions corresponding to higher vehicle ride height comfort modes and lower vehicle ride height sport modes. The mechanism is applicable to a number of active aerodynamic elements, such as rear wings and spoilers, tire wake deflectors, air dams, underbody devices, diffusers, etc. Multiple mechanisms may be used across the entire vehicle or used in isolation.

In a principal aspect of the invention, an adjustable ride height vehicle aerodynamic system comprises an aerodynamic element ride actuator and an aerodynamic element angle actuator connected in series and mounted in a vehicle, an aerodynamic element adapted to rest in an inactive stowed position and to move from the stowed position to at least one active deployed position at an angle in relation to the vehicle under the control of the aerodynamic element angle actuator to alter vehicle aerodynamic characteristics, the aerodynamic element ride actuator adapted to extend and retract synchronously when a vehicle ride height is respectively increased and decreased, and the aerodynamic element angle actuator adapted to extend and retract respectively to deploy and to stow the aerodynamic element.

In a further aspect of the invention, the aerodynamic element ride actuator is adapted to extend and retract synchronously when a vehicle ride height is respectively increased and decreased to maintain a predetermined spatial relationship between a lowest extent of the aerodynamic element and a driving surface.

In a further aspect of the invention, the aerodynamic element angle actuator is rotatably connected to the aerodynamic element by a connecting link.

In a further aspect of the invention, a first angle is maintained between the connecting link and the aerodynamic element from the stowed position to the at least one deployed position.

In a further aspect of the invention, the at least one deployed position comprises both a fully extended deployed position and a partially extended deployed position.

In a further aspect of the invention, the angles of the aerodynamic element in relation to the vehicle in the fully extended position and in the partially extended position differ depending on whether the vehicle ride height is increased or decreased.

In a further aspect of the invention, a second angle is maintained between the connecting link and the aerodynamic element when the vehicle ride height is decreased and the aerodynamic element is in the stowed position.

In a further aspect of the invention, the angle of the aerodynamic element in relation to the vehicle in the at least one deployed position differs depending on whether the vehicle ride height is increased or decreased.

In a further aspect of the invention, the aerodynamic element ride actuator and the aerodynamic element angle actuator operate hydraulically.

In a further aspect of the invention, at least one of the aerodynamic element ride actuator and the aerodynamic element angle actuator is single acting with a coil spring return.

In a further aspect of the invention, at least one of the aerodynamic element ride actuator and the aerodynamic element angle actuator is dual acting.

In a further aspect of the invention, the aerodynamic element ride actuator and the aerodynamic element angle actuator are constrained by a connecting bracket to operate in series.

In a further aspect of the invention, an element coil spring connects the connecting link and the aerodynamic element.

In a further aspect of the invention, a hard stop feature prevents excess angular extension of the aerodynamic element when the vehicle ride height is decreased and the aerodynamic element is parallel with the vehicle underbody.

In a further aspect of the invention, an adjustable ride height vehicle aerodynamic system is mounted to an underside of the vehicle forward of each of two vehicle front wheels.

In a further aspect of the invention, an adjustable ride height vehicle aerodynamic system is mounted to an underside of the vehicle either forward or rearward of each of two vehicle rear wheels.

In a further aspect of the invention, the aerodynamic element is integrated into a diffuser.

In a further aspect of the invention, a method of operating an adjustable ride height vehicle aerodynamic system comprises connecting a vehicle ride height adjustment system to an aerodynamic element ride actuator of the adjustable ride height vehicle aerodynamic system mounted to the vehicle, controlling the aerodynamic element ride actuator with the vehicle ride height adjustment system to extend and retract the aerodynamic element ride actuator synchronously with respective increases and decreases in vehicle ride height, and extending and retracting an aerodynamic element angle actuator connected in series with the aerodynamic element ride actuator to respectively deploy and stow an aerodynamic element.

In a further aspect of the method of the invention, the aerodynamic element angle actuator is controlled by a vehicle active aerodynamics system.

In a further aspect of the method of the invention, the aerodynamic element angle actuator is controlled by an independent aerodynamic element hydraulic circuit.

### BRIEF DESCRIPTION OF THE DRAWINGS

FIG. 1A is a partial plan view of a vehicle schematically showing the adjustable ride height aerodynamic system mounted forwardly of the front wheels.

FIG. 1B is a partial elevation view of the vehicle of FIG. 1A showing the aerodynamic element of the adjustable ride height aerodynamic system in the stowed baseline position parallel to the driving surface.

FIG. 2 illustrates the vehicle with adjustable ride height aerodynamic system of FIG. 1B showing four system configurations comprising combinations of normal ride height (N), lower ride height (L), and stowed baseline position (B) and deployed positions (D) of the aerodynamic element.

FIG. 3 is a schematic elevation view of the adjustable ride height aerodynamic system.

FIG. 4A is a top perspective view of the adjustable ride height aerodynamic system.

FIG. 4B is a plan view of the adjustable ride height aerodynamic system.

FIG. 4C is a bottom perspective view of the adjustable ride height aerodynamic system.

FIG. 4D is an elevation view of the adjustable ride height aerodynamic system.

FIG. 5 is an elevation schematic illustration of the adjustable ride height aerodynamic system of FIGS. 1A, 1B, 6 and 7 along with a key showing four system configurations of the system comprising combinations of normal ride height (N), lower ride height (L), and stowed baseline position (B) and deployed positions (D) of the aerodynamic element.

FIG. 6 is an illustration of the vehicle and the adjustable ride height aerodynamic system of FIGS. 1B and 4D showing the vehicle and the isolated adjustable ride height aerodynamic system in elevation in four system configurations comprising combinations of normal ride height (N), lower ride height (L), and stowed baseline position (B) and deployed positions (D) of the aerodynamic element.

FIG. 7 is a partial elevation view of a vehicle showing the adjustable ride height aerodynamic system mounted forwardly of the rear wheels in four configurations comprising combinations of normal ride height (N), lower ride height (L), and stowed baseline position (B) and deployed positions (D) of the aerodynamic element.

FIG. 8 is a partial elevation view of a vehicle showing the adjustable ride height aerodynamic system mounted rearwardly of the rear wheels in four system configurations comprising combinations of normal ride height (N), lower ride height (L), and stowed baseline position (B) and deployed positions (D) of the aerodynamic element.

FIG. 9 is an elevation schematic illustration of the adjustable ride height aerodynamic system of FIG. 8 along with a key showing four system configurations comprising combinations of normal ride height (N), lower ride height (L), and stowed baseline position (B) and deployed positions (D) of the aerodynamic element.

FIG. 10 is a perspective view of the underside of a vehicle illustrating the adjustable ride height aerodynamic system integrated into a diffuser at the rear of the vehicle.

### DETAILED DESCRIPTION

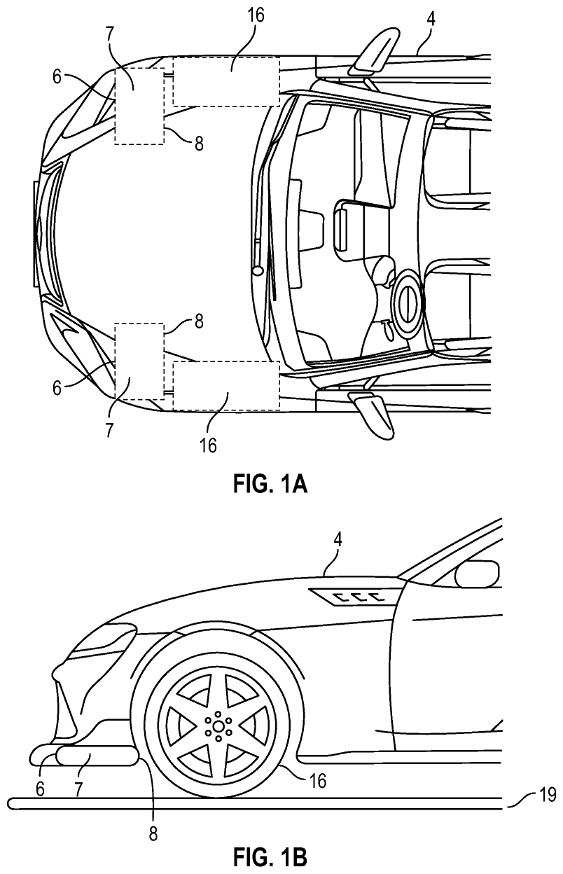

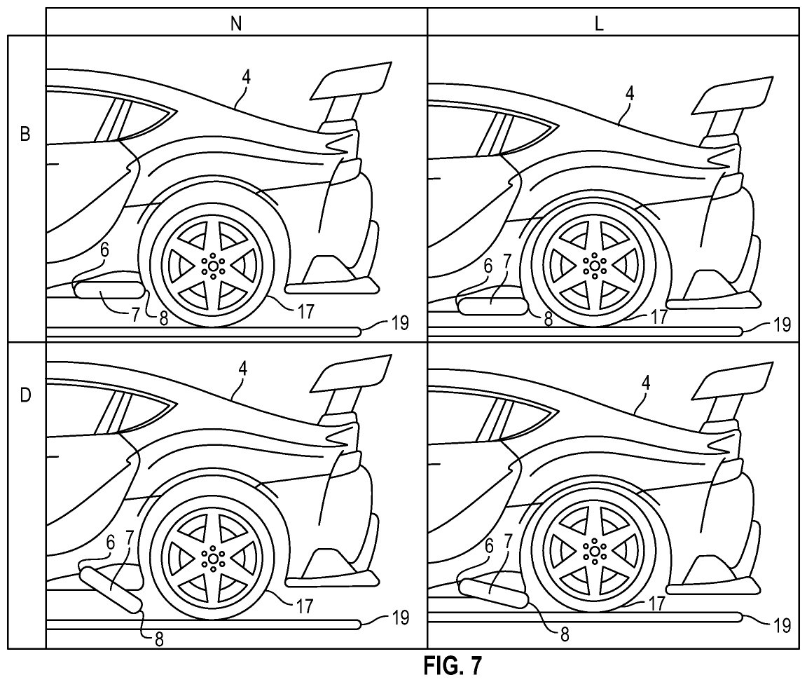

An adjustable ride height vehicle aerodynamic system (1) is illustrated in FIGS. 1A through 10. The adjustable ride height aerodynamic system (1) uses two hydraulic actuators connected in series. These comprise an aerodynamic element ride actuator (3) and an aerodynamic element angle actuator (5). Together, these actuators control the position of an aerodynamic element (7).

The aerodynamic element ride actuator (3) is linked to a vehicle (4) by a rotational joint (9) and to a conventional vehicle ride height system (not illustrated), such that a change in vehicle ride height will automatically result in the activation of the aerodynamic element ride actuator (3). Often, a vehicle with adjustable ride height capability is provided with vehicle suspension hydraulic actuators as part of the suspension system. The aerodynamic element ride actuator (3) may be on the same hydraulic circuit as the vehicle suspension hydraulic actuators, which ensures that the aerodynamic element ride actuator (3) and the vehicle suspension system actuator are synchronized and linked together.

The aerodynamic element angle actuator (5) is driven by the conventional vehicle active aerodynamics system. The aerodynamic element angle actuator (5) may be on the same hydraulic circuit as other vehicle aerodynamic hydraulic actuators, which ensures that these are synchronized and linked together. Alternatively, where independent control of multiple active aerodynamic devices is required, each aerodynamic element angle actuator (5) may be separately linked to an independent aerodynamic element hydraulic circuit.

Typically, the aerodynamic element ride actuator (3) will have a different actuation stroke length than the aerodynamic element angle actuator (5).

A connecting link (11) attaches the aerodynamic element angle actuator (5) to the aerodynamic element (7). The connecting link (11) can rotate relative to the aerodynamic element (7), however the connecting link (11) and aerodynamic element (7) are typically sprung together to a first defined position, at a first angle, using an element coil spring (13) or other suitable energy storage element, such as a polymeric elastomeric element. There is a separate hard stop feature (15) which limits the baseline position of the aerodynamic element (7). This allows the remainder of the adjustable ride height aerodynamic system (1) to move independently of the aerodynamic element (7), and to maintain the same baseline aerodynamic element (7) position, independently of vehicle ride height.

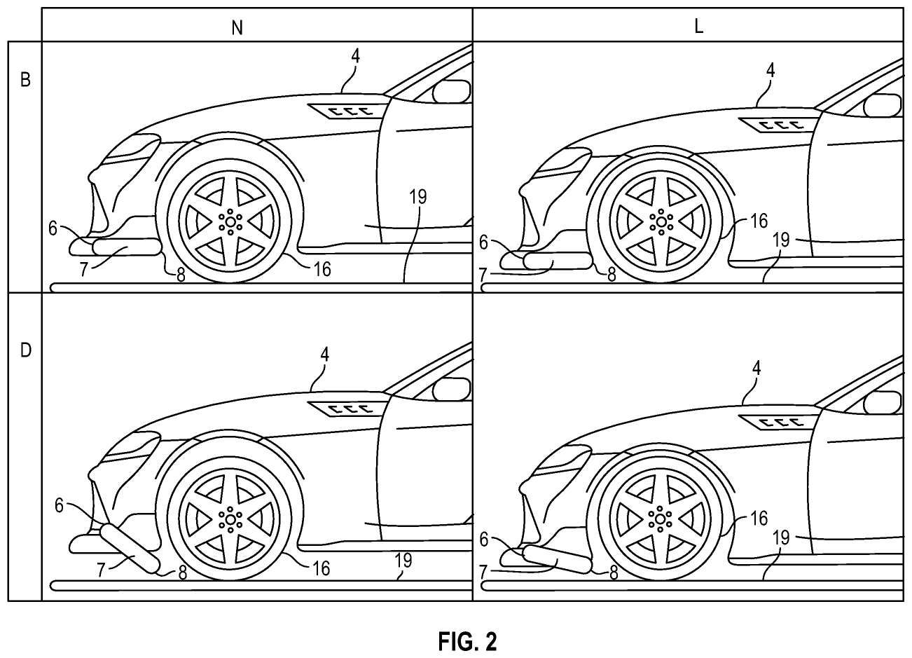

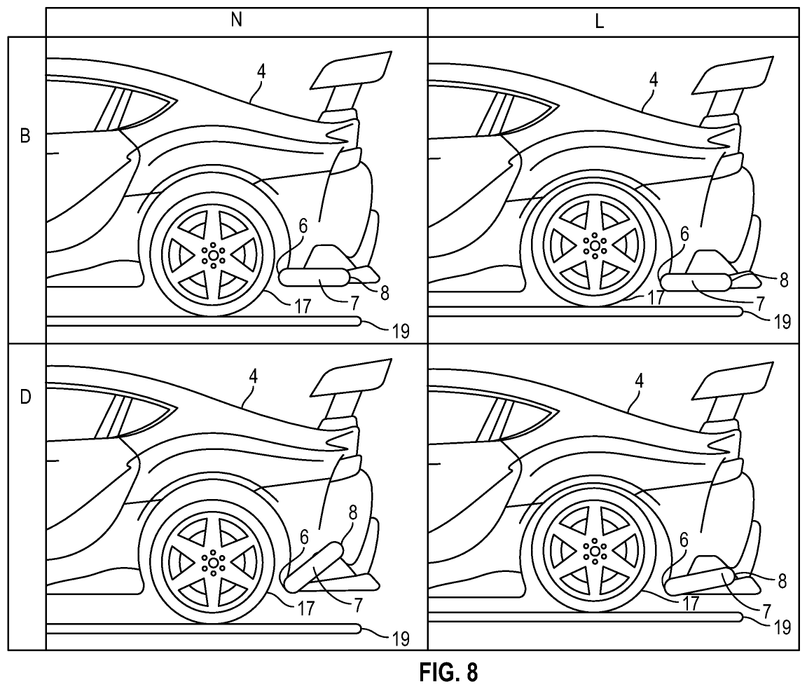

When used forwardly of vehicle front wheels (16) or vehicle rear wheels (17), the adjustable ride height aerodynamic system (1) is configured to rotate a trailing edge (8) of the aerodynamic element (7) downwards from a stowed horizontal baseline position (B) to a deployed position (D). See, for example, FIGS. 2, 3, 5, 6 and 7. When used rearwardly of the vehicle rear wheels (17), the adjustable ride height aerodynamic system (1) may be reconfigured to rotate the trailing edge (8) of the aerodynamic element (7) upwardly from the stowed horizontal baseline position (B) to the deployed position (D). See, for example, FIGS. 8, 9 and 10. The fundamentals remain the same when the aerodynamic element (7) is mounted rearwardly of the vehicle rear wheels (17), however, the element spring (13) now works to push the connecting link (11) and the aerodynamic element (7) apart to another defined position, the first angle of which may be different from that previously described where the adjustable ride height aerodynamic system is mounted forwardly of the front or rear wheels (16, 17). For example, the aerodynamic element actuators (3, 5) may be configured such that a vehicle lower ride height mode (L) produces a lesser deployed aerodynamic element (7) angle than does the normal, higher vehicle ride height mode (N). The inverse may be achieved by changing the horizontal baseline position (B) of the aerodynamic element ride actuator (3). Whether the adjustable ride height aerodynamic system is mounted forwardly or rearwardly of a wheel, in the lower ride height mode (L) with the aerodynamic element (7) in the stowed horizontal baseline position (B), the connecting link (11) and the aerodynamic element (7) are typically sprung together to a second defined position, at a second angle different from the first angle, using the element coil spring (13) or other suitable energy storage element.

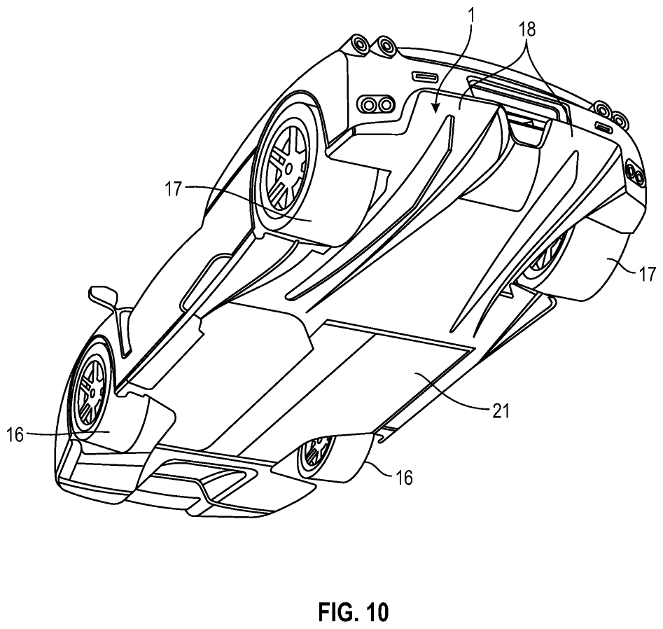

The adjustable ride height aerodynamic system (1) may be applied to a variety of active aerodynamic elements, such as rear wings and spoilers, tire wake deflectors, air dams, underbody devices, diffusers, etc. An example of the adjustable ride height aerodynamic system (1) integrated into a diffuser (18) is illustrated in FIG. 10. A diffuser is a shaped section of the rear of a vehicle which improves the vehicle's aerodynamic properties. This is accomplished by enhancing the transition between high velocity airflow beneath the vehicle and slower airflow of the ambient air. By accelerating the airflow in front of it, the diffuser helps to generate downforce. A rake angle of the diffuser creates a change in velocity of the air flowing under it. This then generates a change in pressure and increased down force. Depending on the aerodynamic requirements of the specific vehicle, it may be desirable to have a diffuser angle that varies with ride height. This matches with the functionality of the adjustable ride height aerodynamic system (1).

Depending on vehicle ride height, the requirements of the aerodynamic element (7) may be different. For example, for optimal performance in the vehicle sport, lower ride height mode (L), the aerodynamic element (7) may deploy to a different position, at a different angle to the driving surface (19), than it would for optimal performance in the normal, higher vehicle ride height mode (N). Another reason for this functionality is to ensure adequate ground clearance of the aerodynamic element (7) depending on vehicle ride height. Ideally, a predetermined distance between the lowest extent of the aerodynamic element (7) and the driving surface (19) is maintained, depending on the driving mode. The lowest extent of the aerodynamic element (7) is typically in the vicinity of the rearward, trailing edge (8) when the adjustable ride height aerodynamic system is mounted forwardly of front or rear wheels (16, 17), and in the vicinity of the forward, leading edge (6) when the adjustable ride height aerodynamic system (1) is mounted rearwardly of rear wheels (17). The predetermined distance need not be identical in all cases and may vary depending on road conditions or other driving parameters. A vehicle underbody (21) is generally parallel to the driving surface (19). The aerodynamic element (7) will be oriented either parallel to the vehicle underbody (21) in the horizontal baseline position (B) or at an angle to the vehicle underbody (21) in the deployed position (D).

The adjustable ride height aerodynamic system (1) may be employed alone or in pairs. The system is generally employed in pairs adjacent to vehicle front wheels (16) or vehicle rear wheels (17), or both.

For example, pairs of the adjustable ride height aerodynamic system (1) may be mounted to a vehicle underbody (21) forward of the front wheels (16). In the default configuration, the vehicle is in the normal, higher ride height mode (N). In this configuration, each aerodynamic element (7) may be maintained stowed parallel to the vehicle underbody (21) or deployed at an angle to the vehicle underbody (21). When deployed, each aerodynamic element (7) rotates along an axis (X) adjacent the forward, leading edge (6) of the aerodynamic element (7) to tip the rearward, trailing edge (8) of the aerodynamic element (7) downwards. When the vehicle ride height is lowered to the sport, lower ride height mode (L), each aerodynamic element (7) is also stowed parallel to the vehicle underbody (21) and deployed with the rearward, trailing edge (8) tipped downward. The angle of the aerodynamic element (7) when deployed may be different depending on the chosen vehicle ride height. This will prevent contact of the aerodynamic element (7) with the driving surface (19) and may also affect the aerodynamic characteristics of the adjustable ride height aerodynamic system (1).

The aerodynamic element ride actuator (3) and the aerodynamic element angle actuator (5) operate in series. This may be accomplished by mounting them both within a connecting bracket (27). They may be single acting actuators, each with a return spring, or dual acting actuators which do not require a return spring. For example, in the case of single acting actuators, the aerodynamic element ride actuator (3) may be provided with a ride actuator return spring (37) and the aerodynamic element angle actuator (5) may be provided with an angle actuator return spring (39). The aerodynamic element ride actuator (3) is typically rotatably connected at its forward end to a body of the vehicle (4) via a mounting bracket (31). The aerodynamic element ride actuator (3) may retract from its default position in synchronization with a reduction in vehicle ride height. This ensures that the aerodynamic element (7) may remain stowed parallel to the vehicle underbody (21) regardless of vehicle ride height. By connecting the aerodynamic element ride actuator (3) to the vehicle suspension ride height circuit, the retraction and return to default position of the aerodynamic element ride actuator (3) may be synchronized without the need for additional sensors or electronic components.

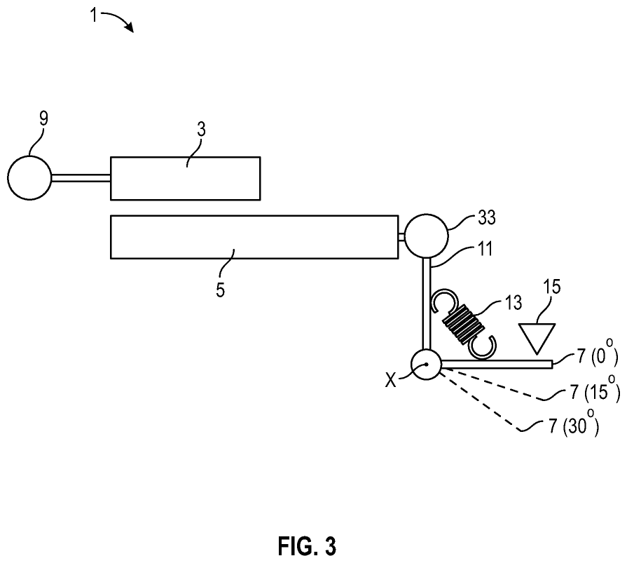

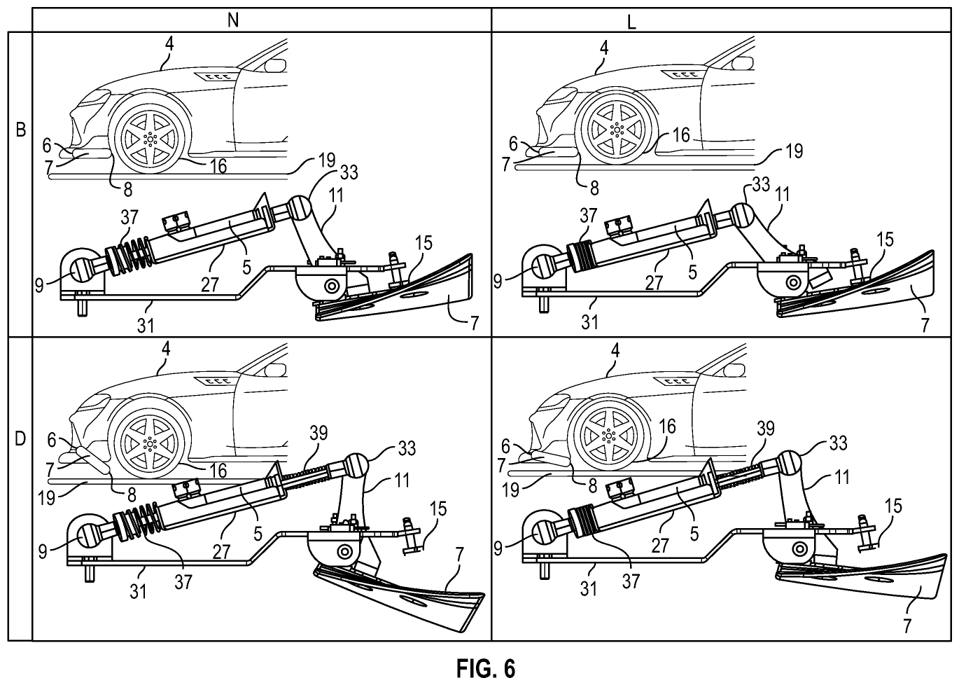

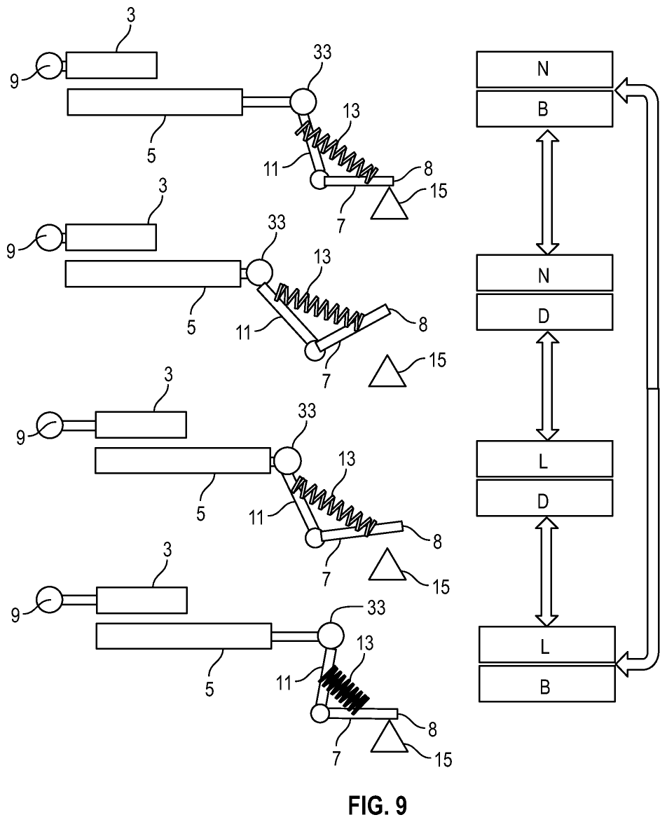

While the aerodynamic element ride actuator (3) maintains a spatial relationship between the aerodynamic element (7) and the body of the vehicle (4), the aerodynamic element angle actuator (5) controls the deployment and return to stowed, baseline position (B) of the aerodynamic element (7). The aerodynamic element angle actuator (5) extends upon activation of the vehicle aerodynamic hydraulic system. A rearward end (33) of the aerodynamic element angle actuator (5) is rotatably connected to a first end of the connecting link (11) which extends between the aerodynamic element angle actuator (5) and the aerodynamic element (7). The connecting link (11) is also rotatably connected at a second end of the connecting link (11) to the aerodynamic element (7). Typically, the element coil spring (13) connects the connecting link (11) and the aerodynamic element (7). When the aerodynamic element angle actuator (5) is not extended, the aerodynamic element (7) is stowed. Depending on the degree to which the aerodynamic element angle actuator (5) is extended, the aerodynamic element (7) may be deployed to various positions, for example to 15 degrees (in the low ride height mode L) or 30 degrees (in the normal ride height mode N) from parallel to the vehicle underbody (21), as illustrated in FIG. 3. The element coil spring (13) maintains a constant angle between the connecting element (11) and the aerodynamic element (7) as the aerodynamic element (7) is deployed. The hard stop feature (15), which may be made, for example, of a resilient, or relatively rigid, polymeric material, is mounted above the aerodynamic element (7) when the aerodynamic element (7) is mounted forwardly of one of the front or rear wheels (16, 17), as illustrated in FIG. 6. Alternatively, the hard stop feature (15) is mounted below the aerodynamic element (7) when the aerodynamic element (7) is mounted rearwardly of one of the rear wheels (17), as illustrated in FIG. 9. The hard stop feature (15) prevents the aerodynamic element (7) from moving past parallel with the vehicle underbody (21) when the aerodynamic element (7) is in the stowed baseline position (B).

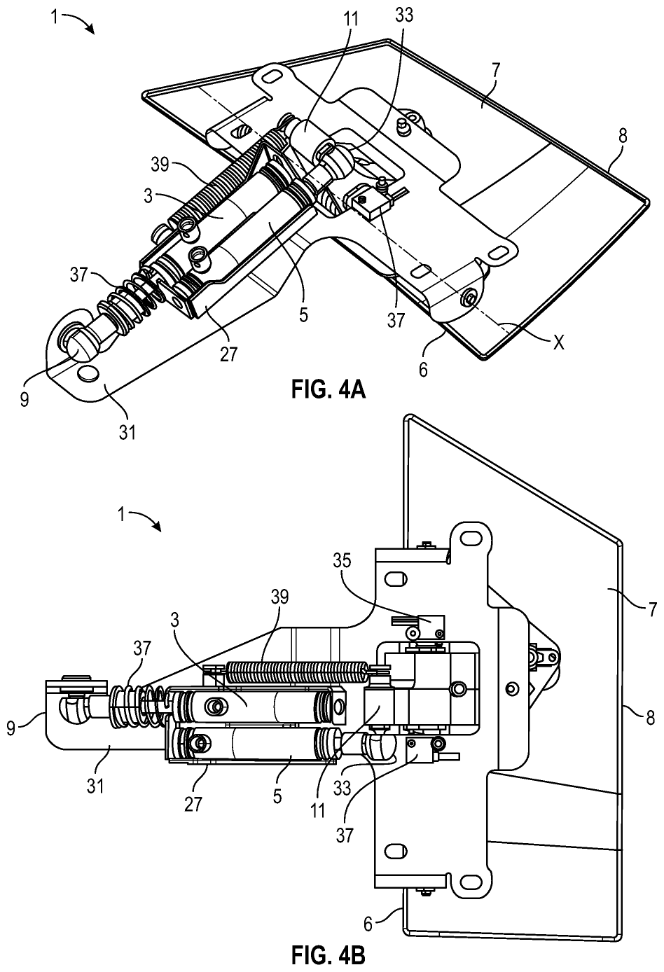

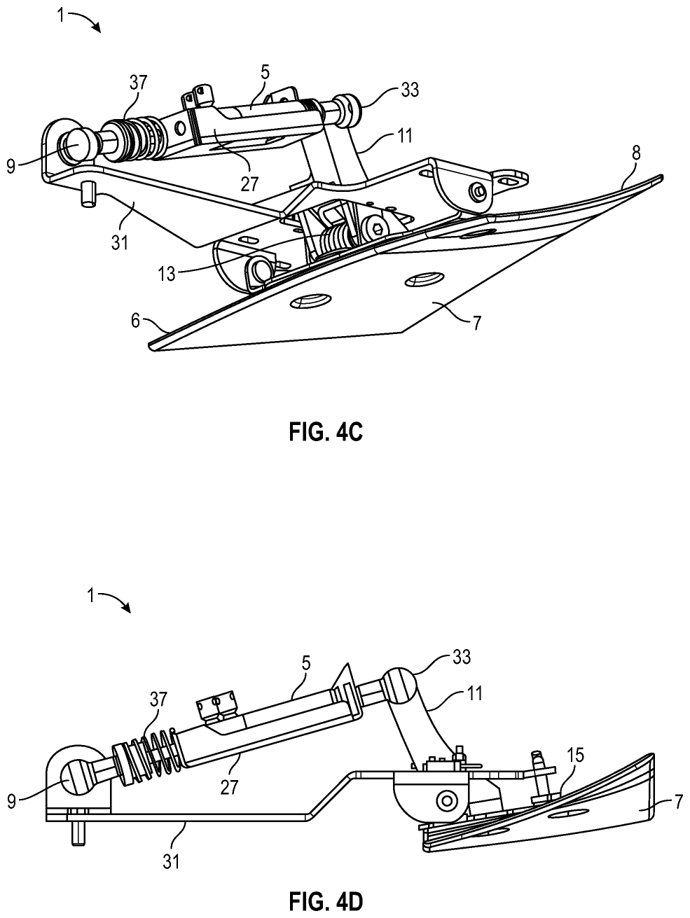

Microswitches or other electronic sensors may be employed to sense the position of the aerodynamic element (7). They are so used for position feedback only, and not for control of the aerodynamic element (7). These may comprise microswitches to sense an open position and a closed position. For example, an open position microswitch (35) and a closed position microswitch (36) may be provided, as illustrated in FIGS. 4A and 4B. The adjustable ride height aerodynamic system (1) may operate without reliance on additional sensors or electronic components to control the variation in aerodynamic positions of the aerodynamic element depending on vehicle ride height.

As noted, a pair of adjustable ride height aerodynamic systems (1) are normally mounted forwardly of vehicle front wheels (16) but may be mounted forwardly or rearwardly of vehicle rear wheels (17). Again, the aerodynamic element (7) may be maintained stowed parallel with the vehicle underbody (21) in both the normal, higher vehicle ride height mode (N) and the sport, lower vehicle ride height mode (L). When mounted forwardly of the rear wheels (17), the adjustable ride height aerodynamic systems (1) operate as they do when mounted forwardly of the front wheels (16). When mounted rearwardly of a rear wheel (17), as illustrated in FIGS. 8 and 9, the rearward, trailing edge (8) of the aerodynamic element (7) is preferably tipped upwards toward the vehicle underbody (21) when deployed. Again, the angle of the deployed aerodynamic element (7) in relation to the vehicle underbody (21) may be varied depending on vehicle ride height. In this case, the hard stop feature (15) is mounted below the aerodynamic element (7) to prevent the aerodynamic element (7) from rotating below parallel to the vehicle underbody (21). The element coil spring (13) connecting the connecting link (11) and the aerodynamic element (7) will be extended except when the adjustable ride height aerodynamic system (1) is in the low ride height mode (L) with the aerodynamic element (7) stowed. In this baseline position (B), the element coil spring (13) is compressed, and the aerodynamic element (7) contacts the hard stop feature (15).

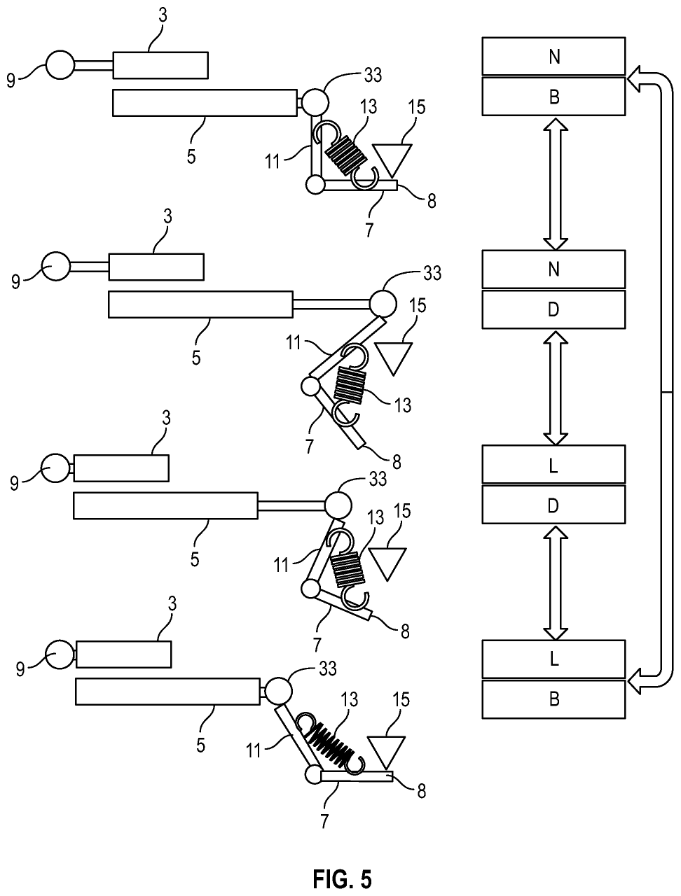

FIGS. 2, 5, 6 and 7 show the aerodynamic system mechanism (1) schematically in four different configurations. These may be described from top to bottom in FIG. 5, or counterclockwise from the upper left in FIGS. 2, 6 and 7, as NB (normal, higher ride height (N) and stowed parallel baseline position (B) of aerodynamic element (7)), ND (normal, higher ride height (N) and deployed position (D) of aerodynamic element (7)), LD (lower ride height (L) and deployed position (D) of aerodynamic element (7)) and LB (lower ride height (L) and stowed parallel baseline position (B) of aerodynamic element (7)). These configurations may be used when the adjustable ride height aerodynamic system (1) is mounted forwardly of the vehicle front wheels (16) or the vehicle rear wheels (17). In the NB configuration, the aerodynamic element ride actuator (3) is extended, the aerodynamic element angle actuator (5) is not extended, and the aerodynamic element (7) is in contact with the hard stop feature (15). In the ND configuration, the aerodynamic element ride actuator (3) remains extended, the aerodynamic element angle actuator (5) is also extended, and the aerodynamic element (7) is not in contact with the hard stop feature (15). In the LD configuration, the aerodynamic element ride actuator (3) is no longer extended, the aerodynamic element angle actuator (5) remains extended, and the aerodynamic element (7) is still not in contact with the hard stop feature (15). In the LB configuration, the aerodynamic element ride actuator (3) remains not extended, the aerodynamic element angle actuator (5) is also not extended, and the aerodynamic element (7) is again in contact with the hard stop feature (15).

FIGS. 8 and 9 also show the adjustable ride height aerodynamic system (1) schematically in four different configurations. These may be described from top to bottom in FIG. 9, or counterclockwise from the upper left in FIG. 8, as NB (normal, higher ride height (N) and stowed parallel baseline position (B) of aerodynamic element (7)), ND (normal, higher ride height (N) and deployed position (D) of aerodynamic element (7)), LD (lower ride height (L) and deployed position (D) of aerodynamic element (7)) and LB (lower ride height (L) and stowed parallel baseline position (B) of aerodynamic element (7)). These configurations may be used when the adjustable ride height aerodynamic system (1) is mounted rearwardly of the vehicle rear wheels (17). In the NB configuration, the aerodynamic element ride actuator (3) is not extended, the aerodynamic element angle actuator (5) is extended, and the aerodynamic element (7) is in contact with the hard stop feature (15). In the ND configuration, the aerodynamic element ride actuator (3) remains not extended, the aerodynamic element angle actuator (5) is now also not extended, and the aerodynamic element (7) is not in contact with the hard stop feature (15). In the LD configuration, the aerodynamic element ride actuator (3) is now extended, the aerodynamic element angle actuator (5) remains not extended, and the aerodynamic element (7) is still not in contact with the hard stop feature (15). In the LB configuration, the aerodynamic element ride actuator (3) remains extended, the aerodynamic element angle actuator (5) is also extended, and the aerodynamic element (7) is again in contact with the hard stop feature (15).

It should be understood that although particular component arrangements are disclosed in the illustrated embodiments, other arrangements will benefit from this invention. Although particular step sequences are shown and described, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although example embodiments have been disclosed, a worker of ordinary skill in this art would recognize that certain modifications would come within the scope of the claims.

1. An adjustable ride height vehicle aerodynamic system, comprising:
an aerodynamic element ride actuator and an aerodynamic element angle actuator connected in series and mounted in a vehicle;
an aerodynamic element adapted to rest in an inactive stowed position and to move from the stowed position to at least one active deployed position at an angle in relation to the vehicle under the control of the aerodynamic element angle actuator to alter vehicle aerodynamic characteristics;
the aerodynamic element ride actuator adapted to extend and retract synchronously when a vehicle ride height is respectively increased and decreased;
the aerodynamic element angle actuator adapted to extend and retract respectively to deploy and to stow the aerodynamic element.

2. The adjustable ride height vehicle aerodynamic system of claim 1, wherein the aerodynamic element ride actuator is adapted to extend and retract synchronously when a vehicle ride height is respectively increased and decreased to maintain a predetermined spatial relationship between a lowest extent of the aerodynamic element and a driving surface.

3. The adjustable ride height vehicle aerodynamic system of either of claims 1 and 2, wherein the aerodynamic element angle actuator is rotatably connected to the aerodynamic element by a connecting link.

4. The adjustable ride height vehicle aerodynamic system of any of claims 1 to 3, wherein a first angle is maintained between the connecting link and the aerodynamic element from the stowed position to the at least one deployed position.

5. The adjustable ride height vehicle aerodynamic system of any one of claims 1 to 4, wherein the at least one deployed position comprises both a fully extended deployed position and a partially extended deployed position.

6. The adjustable ride height vehicle aerodynamic system of claim 5, wherein the angles of the aerodynamic element in relation to the vehicle in the fully extended deployed position and the partially extended deployed position differ depending on whether the vehicle ride height is increased or decreased.

7. The adjustable ride height vehicle aerodynamic system of claim 3, wherein a second angle is maintained between the connecting link and the aerodynamic element when the vehicle ride height is decreased and the aerodynamic element is in the stowed position.

8. The adjustable ride height vehicle aerodynamic system of claim 1, wherein the angle of the aerodynamic element in relation to the vehicle in the at least one deployed position differs depending on whether the vehicle ride height is increased or decreased.

9. The adjustable ride height vehicle aerodynamic system of any one of claims 1 to 8, wherein the aerodynamic element ride actuator and the aerodynamic element angle actuator operate hydraulically.

10. The adjustable ride height vehicle aerodynamic system of any one of claims 1 to 9, wherein at least one of the aerodynamic element ride actuator and the aerodynamic element angle actuator is single acting with a coil spring return.

11. The adjustable ride height vehicle aerodynamic system of any one of claims 1 to 9, wherein at least one of the aerodynamic element ride actuator and the aerodynamic element angle actuator is dual acting.

12. The adjustable ride height vehicle aerodynamic system of any one of claims 1 to 11, wherein the aerodynamic element ride actuator and the aerodynamic element angle actuator are constrained by a connecting bracket to operate in series.

13. The adjustable ride height vehicle aerodynamic system of any one of claims 1 to 12, wherein an element coil spring connects the connecting link and the aerodynamic element.

14. The adjustable ride height vehicle aerodynamic system of any one of claims 1 to 13, wherein a hard stop prevents excess angular extension of the aerodynamic element when the vehicle ride height is decreased and the aerodynamic element is parallel with the vehicle.

15. The adjustable ride height vehicle aerodynamic system of any one of claims 1 to 14, wherein the adjustable ride height vehicle aerodynamic system is mounted to an underside of the vehicle forward of each of two vehicle front wheels.

16. The adjustable ride height vehicle aerodynamic system of any one of claims 1 to 14, wherein the adjustable ride height vehicle aerodynamic system is mounted to an underside of the vehicle either forward or rearward of each of two vehicle rear wheels.

17. The adjustable ride height vehicle aerodynamic system of any one of claims 1 to 14, wherein the aerodynamic element is integrated into a diffuser.

18. A method of operating an adjustable ride height vehicle aerodynamic system comprising:
connecting a vehicle ride height adjustment system to an aerodynamic element ride actuator of the adjustable ride height vehicle aerodynamic system mounted to the vehicle;
controlling the aerodynamic element ride actuator with the vehicle ride height adjustment system to extend and retract the aerodynamic element ride actuator synchronously with respective increases and decreases in vehicle ride height; and
extending and retracting an aerodynamic element angle actuator connected in series with the aerodynamic element ride actuator to respectively deploy and stow an aerodynamic element.

19. The method of claim 18, wherein the aerodynamic element angle actuator is controlled by a vehicle active aerodynamic system.

20. The method of claim 18, wherein the aerodynamic element angle actuator is controlled by an independent aerodynamic hydraulic circuit.

21. The method of claim 18, wherein the aerodynamic ride actuator and the aerodynamic element angle actuator are hydraulic actuators.
